(19) United States
(12) Patent Application Publication
(10) Pub. No.: US 2026/0306963 A1
(43) Pub. Date: Oct. 8, 2026

(54) Gesture-Activated Electronic Toy with Text-Based Artificial Intelligence Response

(71) Applicant: August Karlstedt, Hanover Park, IL (US)

(72) Inventor: August Karlstedt, Hanover Park, IL (US)

(21) Appl. No.: 19/637,402

(22) Filed: Apr. 2, 2026

Related U.S. Application Data
(60) Provisional application No. 63/781,999, filed on Apr. 2, 2025.

(51) Int. Cl. A63H 33/26; G06F 3/01; G10L 15/183; G10L 15/22; G10L 15/30

(52) U.S. Cl. CPC A63H 33/26; G06F 3/017; G10L 15/183; G10L 15/22; G10L 15/30; A63H 2200/00

(57) ABSTRACT

An electronic toy includes a processor, a motion sensor, a microphone, a display, a wireless communication module, and a battery. The processor operates in a non-listening state in which audio is not actively captured. Upon detection of a shaking motion by the motion sensor, an activation signal causes the processor to transition to an active state. The device activates the microphone to capture user speech, transmits the captured speech via the wireless communication module to a remote server for processing by an artificial intelligence system, and receives a text response generated by the artificial intelligence system. The display presents the text response to the user. The processor then returns to the non-listening state. In a preferred embodiment, the device does not include a speaker and responses are presented solely as text on the display. The device may apply content filtering to ensure responses are appropriate for a target user population.

### CROSS-REFERENCE TO RELATED APPLICATIONS

This application claims the benefit of U.S. Provisional Patent Application No. 63/781,999, filed Apr. 2, 2025, entitled “Electronic Toy with AI Response,” the entire contents of which are incorporated herein by reference in their entirety.

### FIELD OF THE INVENTION

The present invention relates generally to interactive electronic toys and, more particularly, to portable handheld electronic toys that provide artificial intelligence responses to user speech following a gesture-based activation event, without requiring continuous audio monitoring.

### BACKGROUND OF THE INVENTION

Handheld electronic devices and interactive toys have evolved significantly to incorporate increasingly sophisticated functionality. Despite these advances, a persistent gap exists between devices that are genuinely interactive and intelligent and those that are simple, portable, self-contained, and safe for users of all ages.

Traditional novelty and toy devices—such as fortune-telling balls and randomized response toys—provide only pre-programmed, random, or scripted responses. While entertaining, such devices cannot understand natural language, respond to specific questions, or generate contextually meaningful answers.

Voice-activated artificial intelligence assistants, such as those integrated into smartphones and dedicated smart speakers, can process natural language and generate intelligent responses. However, these systems typically rely on continuous microphone monitoring—commonly referred to as “always-on listening.” This approach raises significant privacy concerns, drains battery life rapidly, and is unsuitable for handheld devices intended for younger users or privacy-sensitive environments. Additionally, such systems are not portable in a simple, self-contained form and require companion devices, account setup, or home infrastructure.

Button-based activation interfaces exist but require deliberate physical interaction with a small control surface, reducing intuitive usability particularly for younger users. They also lack the engaging, tactile, ritual quality that makes interaction feel natural and playful.

There remains a need for a self-contained, handheld electronic device that combines an intentional gesture-based activation—specifically a shaking or physical impact motion—with the intelligence of cloud-based artificial intelligence, while strictly avoiding continuous audio monitoring, preserving user privacy, conserving battery power through hardware-level power management, and requiring no companion device for ongoing interactive use. The present invention addresses this need.

### SUMMARY OF THE INVENTION

In one aspect, the present invention provides an electronic toy comprising: a processor configured to operate in a non-listening state in which audio is not actively captured; a motion sensor configured to detect a shaking motion applied to the toy by a user and generate an activation signal; a microphone configured to capture user speech upon activation; a display configured to present text-based responses to the user; and a communication interface for communicating with an artificial intelligence system. Upon receipt of the activation signal, the processor transitions to an active state, activates the microphone, provides the captured speech to the artificial intelligence system, receives a generated response, causes the display to present the response as text to the user, and returns to the non-listening state. Each interaction requires detection of a new shaking motion.

In a more specific aspect, the present invention provides a gesture-activated electronic toy comprising: a processor configured to transition between a non-listening state and an active state; a motion sensor operably connected to the processor and configured to detect a shaking motion applied to the toy by a user and to generate an activation signal comprising a hardware interrupt in response thereto; a microphone operably connected to the processor and configured to capture user speech upon activation; a display operably connected to the processor and configured to present text-based responses to the user; a wireless communication module operably connected to the processor and configured to provide internet connectivity; and a battery power source, wherein the toy does not include a speaker, and wherein, upon receipt of the activation signal, the processor transitions to the active state, activates the microphone to capture user speech, transmits the captured user speech via the wireless communication module to a remote server for processing by an artificial intelligence system, receives a generated text response, causes the display to present the text response solely as text to the user, and returns to the non-listening state.

In another aspect, the present invention provides a method of operating an electronic toy comprising: maintaining a processor in a non-listening state; detecting a shaking motion applied to the toy by a user; generating an activation signal in response to the detected shaking motion; transitioning the processor to an active state; verifying network connectivity before activating a microphone of the toy; when network connectivity is available, activating the microphone to capture user speech, transmitting the captured user speech via a wireless communication module to a remote server for processing by an artificial intelligence system, receiving a text response generated by the artificial intelligence system, presenting the text response on a display of the toy, and returning the processor to the non-listening state; and, when network connectivity is unavailable, returning the processor to the non-listening state without capturing audio.

In certain preferred embodiments, the device is configured as a handheld toy. In other embodiments, the device may take any portable handheld form factor including novelty devices, consumer electronics, educational devices, desk accessories, or wellness devices. The invention is not limited to any particular form factor or intended use case.

A key advantage of the invention is the elimination of continuous audio monitoring. Audio capture occurs only after detection of an intentional physical gesture, improving user privacy and significantly reducing power consumption compared to always-on systems.

### BRIEF DESCRIPTION OF THE SEVERAL VIEWS OF THE DRAWINGS

The accompanying drawings, which are incorporated in and constitute a part of this specification, illustrate embodiments of the invention and together with the description serve to explain the principles of the invention.

FIG. 1 is a block diagram illustrating the functional hardware components of the gesture-activated device and their interconnections, including the motion sensor, microphone, display, wireless communication module, storage device, battery, and remote server.

FIG. 2 is a flowchart illustrating the captive portal network initialization method, depicting the steps from initial power-up through activation of a temporary wireless access point on the device (100), hosting of a captive portal by the device (100), credential entry by a user via a secondary device, storage of credentials, and connection to a permanent wireless network.

FIG. 3 is a flowchart illustrating the complete operational cycle of the device, including the non-listening state, gesture detection, hardware interrupt wake, internet verification, audio capture, AI processing, response display, and return to the non-listening state.

FIG. 4 is a perspective view of an exemplary handheld embodiment of the electronic toy, shown held in a user's hand, illustrating the enclosure, display, and microphone.

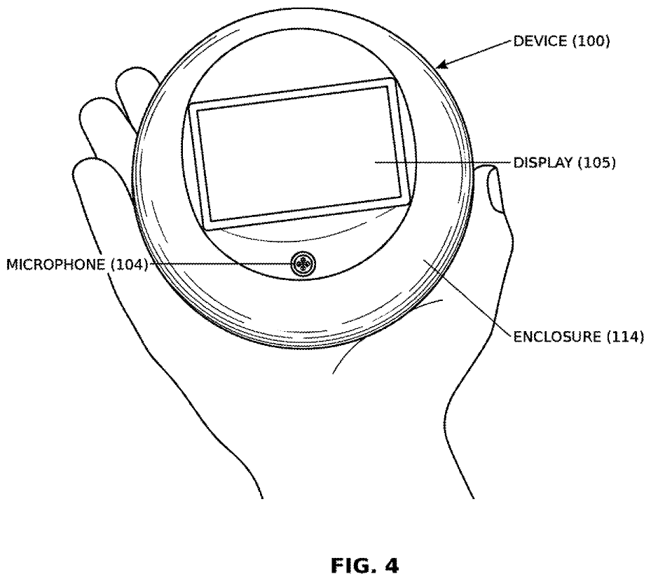

### DETAILED DESCRIPTION OF THE INVENTION

### I. Overview

The following detailed description references the accompanying drawings. The embodiments described are illustrative and not limiting. Other embodiments are possible and modifications may be made without departing from the spirit and scope of the invention as defined by the appended claims.

The present invention provides an interactive electronic device that uses a physical gesture—preferably a shaking or physical impact motion—to trigger an activation signal that transitions a processor from a non-listening state to an active state. Upon activation, the device captures user speech through an audio input component, provides the speech to an artificial intelligence system for processing, receives a generated response, and outputs that response to the user, before returning to the non-listening state. The entire interaction cycle is initiated by a single intentional gesture and requires no companion device during ordinary interactive use, no always-on listening, and no button presses.

As used herein, a “non-listening state” refers to any operational state of the device in which the audio input component is not actively capturing or monitoring audio. In preferred embodiments, the non-listening state corresponds to a low-power deep sleep state of the processor in which most peripheral components are powered down. However, the non-listening state is not limited to a deep sleep state and may include any processor state in which audio capture is inactive.

### II. Hardware Components

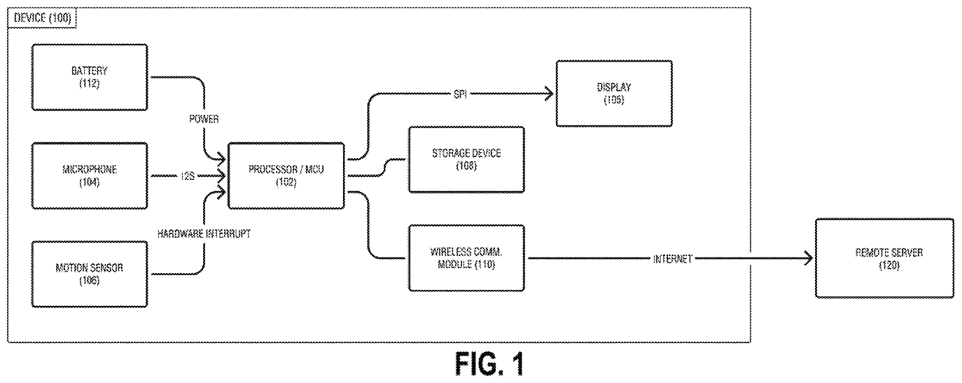

Referring to FIG. 1, the interactive electronic device 100 comprises the following components. Throughout this specification, specific component names (e.g., “motion sensor,” “microphone,” “wireless communication module”) refer to preferred embodiments. The claims may use broader terms (e.g., “motion detection component,” “audio input component,” “communication interface”) that encompass the specific components described herein as well as functional equivalents.

Processor/Microcontroller Unit (MCU) 102: The processor 102 is the central processing unit of the device 100, responsible for coordinating the operation of all components. In preferred embodiments, the processor 102 is a microcontroller unit (MCU). In one particularly preferred embodiment, the processor 102 is an RP2350-based microcontroller, such as the Raspberry Pi Pico 2W, which integrates dual ARM Cortex-M33 cores, 520 KB of on-chip SRAM, and an on-board wireless communication module supporting IEEE 802.11 b/g/n Wi-Fi, in a compact, low-cost, low-power package well suited for battery-powered handheld devices. The processor 102 is configured to operate in at least two states: a non-listening state (which in preferred embodiments is a low-power deep sleep or dormant state in which power consumption is minimized and most peripheral components are inactive), and an active state in which the processor 102 executes the full interaction cycle. The processor 102 transitions from the non-listening state to the active state upon receipt of an activation signal, which in preferred embodiments is a hardware interrupt signal from the motion sensor 106. In alternative embodiments, the processor 102 may be a system-on-chip (SoC), a digital signal processor (DSP), or any suitable processing unit.

Motion Sensor/Motion Detection Component 106: The motion sensor 106 (also referred to herein as a motion detection component) is operably connected to the processor 102 and is configured to detect a physical gesture performed by a user. In preferred embodiments, the motion sensor 106 is a vibration sensor configured to detect a shaking or physical impact motion of sufficient magnitude. In one particularly preferred embodiment, the motion sensor 106 is a passive mechanical vibration sensor comprising a flexible conductive spring coaxially aligned within a conductive metal tube. When the device 100 undergoes a physical impact or shaking motion, the internal spring deforms and makes physical contact with the inner wall of the metal tube, momentarily closing an electrical circuit. This momentary circuit closure generates the activation signal. Because this type of mechanical sensor operates purely on physical contact and requires no continuous active power to monitor motion, it enables a near-zero-power standby state for the motion detection circuitry, further extending battery life. Upon detecting a qualifying motion event, the motion sensor 106 generates an activation signal—which in preferred embodiments is a hardware interrupt signal transmitted directly to a wake-capable GPIO pin of the processor 102—causing the processor 102 to immediately transition to the active state without requiring any software polling loop. In alternative embodiments, the motion sensor 106 may be a three-axis accelerometer, a gyroscope, an inertial measurement unit (IMU), a tilt sensor, or any combination thereof. The physical gesture may include shaking, tapping, squeezing, tilting, impact-based motion, or any other detectable physical motion. Detection thresholds and qualifying motion patterns may be stored in the storage device 108 and may be configurable. In preferred embodiments, the activation signal is generated only when the shaking motion meets or exceeds a predetermined threshold, which may be defined in terms of acceleration magnitude, duration, or a minimum number of repeated acceleration events within a defined time window. This thresholding ensures that incidental or minor movements do not trigger the device, reserving activation for intentional user gestures. The motion sensor 106 remains powered during the non-listening state to enable gesture detection; all other peripheral components may be powered down.

Microphone/Audio Input Component 104: The microphone 104 (also referred to herein as an audio input component) is operably connected to the processor 102 and is configured to capture audio input from a user upon activation by the processor 102. In preferred embodiments, the microphone 104 is a MEMS digital microphone connected to the processor 102 via an Inter-IC Sound (12S) serial bus protocol, enabling high-fidelity digital audio capture without requiring external analog-to-digital conversion. In alternative embodiments, the microphone 104 may be connected via Pulse Density Modulation (PDM), I2C, SPI, or an analog interface with an appropriate analog-to-digital converter. The audio input component is not limited to microphones and may include any component capable of capturing user speech. The microphone 104 is activated only after the processor 102 transitions to the active state. In preferred embodiments, the microphone 104 is inactive during the non-listening state and may be powered down or otherwise disabled until activation, thereby preventing unintended audio capture and conserving battery power.

Display 105: The display 105 is operably connected to the processor 102 and is configured to present information to the user, including the AI-generated response. In preferred embodiments, the display 105 is connected via a Serial Peripheral Interface (SPI) protocol, which facilitates high-speed, synchronous data transmission enabling rapid text rendering. The display 105 may be an LCD, OLED, e-ink, LED matrix, or any suitable display technology. The display 105 may render text responses, animations, graphical elements, or other visual content. In preferred embodiments, the display 105 presents a visual indication of a processing state-such as animated text (e.g., “Thinking . . . ”) or animated graphical elements-between capture of user speech and presentation of the AI-generated response, to inform the user that processing is underway. In embodiments configured as a toy or novelty device, the display 105 may present themed visual elements alongside the AI-generated response.

Wireless Communication Module/Communication Interface 110: The wireless communication module 110 (also referred to herein as a communication interface) is operably connected to the processor 102 and provides connectivity to enable communication with the artificial intelligence system. In preferred embodiments, the module 110 is a Wi-Fi module compliant with IEEE 802.11 standards. In embodiments using an RP2350-based processor such as the Raspberry Pi Pico 2W, the wireless communication module 110 may be integrated on the same board as the processor 102 rather than provided as a separate physical component, though it remains a functionally distinct module. In alternative embodiments, the communication interface may support cellular communication (e.g., 4G LTE, 5G), Bluetooth, or other wireless or wired communication protocols. The module 110 is activated by the processor 102 only during the active state and is powered down during the non-listening state.

Storage Device 108: The storage device 108 is operably connected to the processor 102 and stores firmware, software, configuration data, and network credentials. In preferred embodiments, the storage device 108 is a non-volatile flash memory. Network credentials stored during the initialization process (see Section III below) are retained in the storage device 108 across power cycles. In preferred embodiments, captured audio data is buffered in volatile memory (RAM) of the processor 102 rather than written to the storage device 108, such that audio data exists only transiently in volatile memory during the active state and is automatically discarded when the processor 102 returns to the non-listening state. This architecture provides an additional privacy safeguard by ensuring that no persistent record of captured audio is retained on the device 100. The storage device 108 may also store locally executable fallback responses for use when network connectivity is unavailable.

Battery/Power Source 112: The battery 112 supplies electrical power to all components of the device 100. In preferred embodiments, the battery 112 is one or more standard replaceable cells (e.g., AA alkaline batteries). In alternative embodiments, the power source 112 may be a rechargeable lithium-ion or lithium-polymer battery. The device 100 includes power management circuitry to maximize battery life by aggressively managing component power states, with the processor 102 in the non-listening state and all non-essential components powered down between interactions.

Enclosure 114: The enclosure 114 houses all internal components and is sized and shaped for comfortable single-handed operation. In preferred embodiments, the enclosure 114 is formed from plastic, rubber, or silicone. In toy embodiments, the enclosure 114 may be shaped as a character, a sphere, or other visually engaging form. The display 105 is positioned on an exterior surface of the enclosure 114 visible to the user.

Remote Server/Artificial Intelligence System 120: The remote server 120 is a cloud-based computing system external to the device 100, accessible via the internet through the communication interface 110. The remote server 120 receives audio data from the device 100 and processes the audio to generate a contextually appropriate, open-ended text response. In one embodiment, the remote server 120 performs automatic speech recognition (ASR) to transcribe the audio into text, and passes the transcribed text to an artificial intelligence model—preferably a large language model (LLM)—to generate the text response. In an alternative embodiment, the remote server 120 provides the captured audio directly as input to a multimodal artificial intelligence model that natively accepts audio input, without requiring a separate automatic speech recognition step. In such embodiments, the multimodal model processes the audio input and generates the text response in a single inference operation. The remote server 120 returns the response to the device 100. In preferred embodiments, the remote server 120 applies content filtering to the generated response prior to transmitting the response to the device 100. The content filtering is configured to ensure that responses are appropriate for a target user population, which may include children, students, or other user groups for whom age-appropriate or context-appropriate responses are desired. The content filtering may include keyword filtering, topic restrictions, sentiment analysis, toxicity scoring, or any combination thereof. Content filtering parameters may be configurable by a device administrator through the captive portal interface or through a separate configuration interface. In alternative embodiments, the artificial intelligence system may be partially or fully executed locally on the device 100 using an on-device AI model.

### III. Initialization and Network Credential Setup

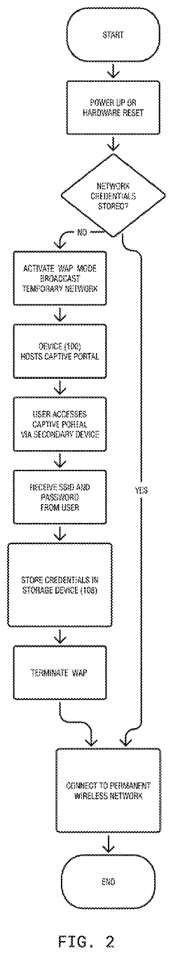

Referring to FIG. 2, upon initial power-up or following a hardware reset, the device 100 may not yet have stored network credentials. To resolve this without requiring a physical keyboard or companion application, the processor 102 directs the wireless communication module 110 to operate as a temporary Wireless Access Point (WAP), broadcasting a local network.

A user connects a secondary computing device—such as a smartphone, tablet, or computer—to the temporary network. The processor 102 hosts a captive portal web page that is automatically presented to the secondary device. The user enters their permanent local Wi-Fi network credentials (SSID and password) into the captive portal interface. The processor 102 receives the credentials, stores them securely in the non-volatile storage device 108, terminates the WAP, and reboots to connect to the standard local wireless network using the stored credentials. This initialization process need only be performed once per network environment.

### IV. Non-Listening State and Interaction Cycle

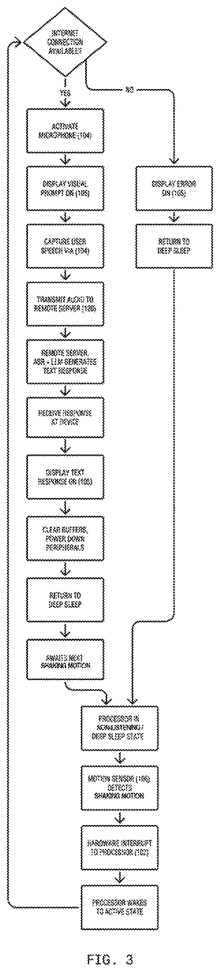

Referring to FIG. 3, the standard operational cycle of the device 100 is designed to maximize battery life and protect user privacy by eliminating always-on listening.
Step 1—Non-Listening State: Following initialization, or after any completed interaction cycle, the processor 102 enters a non-listening state. In preferred embodiments, the non-listening state is a low-power deep sleep state in which the processor 102 minimizes power consumption and peripheral components including the microphone 104, display 105, and wireless communication module 110 are powered down or otherwise disabled until activation. Only the motion sensor 106 and associated interrupt circuitry remain powered, consuming negligible power while continuously monitoring for a qualifying gesture. The audio input component is not active and does not capture or monitor audio during the non-listening state.
Step 2—Gesture Detection and Activation Signal: When a user physically shakes or bumps the device 100 with sufficient force, the motion sensor 106 detects the resulting motion and generates an activation signal. In preferred embodiments, the activation signal is a hardware interrupt signal transmitted directly to the processor 102, which immediately wakes the processor 102 from the non-listening state without requiring any software polling loop, enabling near-instantaneous activation.
Step 3—Internet Connectivity Verification: Upon transitioning to the active state, the processor 102 activates the wireless communication module 110 and verifies that an active internet connection is available using the stored network credentials. If connectivity cannot be verified, the processor 102 outputs an error indication—such as an error message on the display 105—and immediately returns to the non-listening state without activating the microphone 104 or capturing any audio.
Step 4—Audio Capture: If internet connectivity is confirmed, the processor 102 activates the microphone 104. The display 105 presents a visual prompt to indicate to the user that the device is ready to receive a spoken question or statement. The processor 102 captures audio via the microphone 104 for a predetermined duration or until voice activity detection logic determines the user has finished speaking. Audio data is buffered in volatile memory (RAM) of the processor 102. Audio capture is strictly bounded to this active period; no audio is captured before or after.
Step 5—Processing State Indication: After audio capture is complete, the display 105 presents a visual indication of a processing state to inform the user that their input is being processed. In preferred embodiments, this visual indication comprises animated text such as “Thinking . . . ” along with animated graphical elements. The processing state indication is displayed while the device awaits a response from the artificial intelligence system.
Step 6—Transmission to Remote Server: The processor 102 transmits the captured audio data from volatile memory via the wireless communication module 110 to the remote server 120 over a secure connection. In preferred embodiments, transmission occurs over an encrypted channel (e.g., HTTPS or TLS).
Step 7—AI Processing: The remote server 120 (or more broadly, the artificial intelligence system) processes the received audio to generate a text response. In one embodiment, the remote server 120 performs automatic speech recognition on the received audio to produce a text transcription, and the transcribed text is then provided as input to an artificial intelligence model, which generates an open-ended, contextually relevant text response. In an alternative embodiment, the received audio is provided directly as input to a multimodal artificial intelligence model that natively accepts audio input, and the multimodal model generates the text response without requiring a separate speech recognition step. The AI model is not limited to predefined response sets and can respond to questions or statements on any topic within its training.
Step 8—Response Output: The artificial intelligence system transmits the response back to the device 100. The processor 102 receives the response via the communication interface 110, parses the data, and outputs the response to the user. In preferred embodiments, the response is output as text on the display 105. The display 105 may also present accompanying animations or graphical elements. In alternative embodiments, the response may be output via an audio output component such as a speaker, or via both a display and an audio output component.
Step 9—Return to Non-Listening State: After the response is output, the processor 102 clears any audio data remaining in volatile memory, powers down all peripheral components, and immediately returns to the non-listening state to await the next gesture event. Each new interaction requires a new physical gesture, ensuring deliberate, intentional use. Because audio data was buffered only in volatile memory, no persistent record of the captured audio remains on the device 100 after the interaction cycle concludes.

### V. Privacy and Safety

A key advantage of the present invention is its architecture for privacy preservation. The device 100 does not continuously monitor audio. The microphone 104 is active only during the brief active listening window following gesture detection and may be powered only during that window or otherwise disabled outside that window. No audio is captured, stored, or transmitted outside of this active window. Furthermore, because captured audio is buffered only in volatile memory (RAM) rather than written to non-volatile storage, audio data is automatically discarded when the processor 102 returns to the non-listening state. This architecture meaningfully reduces the risk of unintended recording compared to always-on voice assistant systems.

The device 100 does not include a speaker in preferred embodiments. The absence of a speaker is a deliberate design choice in preferred embodiments, providing multiple advantages. First, text-based-only output eliminates audible responses that could be disruptive in shared environments such as classrooms, waiting rooms, or family settings. Second, silent text output enables a private, personal interaction between the user and the device that does not disturb others nearby. Third, the elimination of a speaker and associated audio amplification circuitry reduces component cost, power consumption, and device size. In these preferred embodiments, the display 105 is the sole output modality for AI-generated responses. All responses are presented as text on the display 105, reducing audible privacy concerns in shared environments. The remote artificial intelligence service may implement content filtering to provide age-appropriate responses suitable for multiple user populations.

### VI. Alternative Embodiments

While the preferred embodiment is described above as a handheld device configured as a toy, the invention is not so limited. The device 100 may be embodied in any portable handheld form factor, including a novelty consumer device, desk accessory, educational tool, wellness device, or corporate productivity gadget.

In some embodiments, the device 100 may include an audio output component such as a speaker to deliver responses in audio form in addition to or instead of visual display.

In some embodiments, the device 100 may store a set of locally executable fallback responses in the storage device 108, to be presented when internet connectivity is unavailable. Such fallback responses may include predefined text, educational content, or locally generated outputs.

In some embodiments, the activation gesture may be other than a shaking or impact motion. For example, the activation gesture may be a tap, twist, squeeze, or tilt. The motion detection component 106 and detection algorithms may be configured for any such gesture.

In some embodiments, some or all artificial intelligence processing may be performed locally on the device 100 using an on-device AI model, with the communication interface 110 used only for model updates or not required at all.

In some embodiments, captured audio may alternatively be buffered in non-volatile storage prior to transmission; however, in preferred embodiments, volatile memory buffering is used to enhance privacy as described above.

The foregoing descriptions are presented for purposes of illustration and description only. They are not intended to be exhaustive or to limit the invention to the precise forms disclosed. It is intended that the scope of the invention be defined by the claims and their equivalents.

What is claimed is:

1. An electronic toy comprising: a processor configured to operate in a non-listening state in which audio is not actively captured; a motion sensor operably connected to the processor and configured to detect a shaking motion applied to the device by a user and to generate an activation signal in response thereto; a microphone operably connected to the processor and configured to capture audio input from the user; a display operably connected to the processor and configured to present text-based responses to the user; a wireless communication module operably connected to the processor and configured to provide internet connectivity; and a battery power source, wherein, upon receipt of the activation signal, the processor transitions to an active state and is configured to: activate the microphone to capture user speech; transmit the captured user speech via the wireless communication module to a remote server for processing by an artificial intelligence system; receive a text response generated by the artificial intelligence system; cause the display to present the text response to the user; and return to the non-listening state following presentation of the text response, wherein each interaction requires detection of a new shaking motion.

2. The electronic toy of claim 1, wherein the device does not include a speaker, and wherein the text response is presented to the user solely through the display.

3. The electronic toy of claim 1, wherein the artificial intelligence system comprises a large language model that generates the text response based on the captured user speech, wherein the large language model processes the captured user speech by at least one of: (a) receiving a text transcription produced by performing automatic speech recognition on the captured user speech; or (b) natively receiving the captured user speech as audio input to a multimodal model.

4. The electronic toy of claim 1, wherein the display is further configured to present a visual indication of a processing state between capture of user speech and presentation of the text response.

5. The electronic toy of claim 4, wherein the visual indication of the processing state comprises animated text, animated graphical elements, or both.

6. The electronic toy of claim 1, wherein the display is further configured to present a visual prompt indicating readiness to receive spoken input following activation of the microphone.

7. The electronic toy of claim 1, wherein the remote server is configured to apply content filtering to the text response to ensure the response is appropriate for a target user population.

8. The electronic toy of claim 1, wherein the device comprises an enclosure sized and shaped for single-handed operation by a user.

9. The electronic toy of claim 1, wherein the processor operates in a low-power sleep state during the non-listening state, wherein the motion sensor remains powered during the low-power sleep state to enable detection of the shaking motion, and wherein the activation signal comprises a hardware interrupt that wakes the processor from the low-power sleep state without software polling.

10. An electronic toy comprising: a processor configured to operate in a non-listening state in which audio is not actively captured; a motion sensor operably connected to the processor and configured to detect a shaking motion applied to the toy by a user and to generate an activation signal comprising a hardware interrupt in response thereto; a microphone operably connected to the processor and configured to capture audio input from the user; a display operably connected to the processor and configured to present text-based responses to the user; a wireless communication module operably connected to the processor and configured to provide internet connectivity; and a battery power source, wherein the toy does not include a speaker, and wherein, upon receipt of the activation signal, the processor transitions to an active state and is configured to: activate the microphone to capture user speech; transmit the captured user speech via the wireless communication module to a remote server for processing by an artificial intelligence system; receive a text response generated by the artificial intelligence system; cause the display to present the text response to the user solely through the display; and return to the non-listening state following presentation of the text response, wherein each interaction requires detection of a new shaking motion.

11. The electronic toy of claim 10, wherein, upon transition to the active state, the processor verifies network connectivity before activating the microphone, and wherein, when network connectivity is unavailable, the processor returns to the non-listening state without capturing audio.

12. The electronic toy of claim 10, wherein the artificial intelligence system comprises a large language model that generates the text response based on the captured user speech, wherein the large language model processes the captured user speech by at least one of: (a) receiving a text transcription produced by performing automatic speech recognition on the captured user speech; or (b) natively receiving the captured user speech as audio input to a multimodal model.

13. The electronic toy of claim 10, wherein the display is further configured to present a visual indication of a processing state between capture of user speech and presentation of the text response.

14. The electronic toy of claim 10, wherein the display is further configured to present a visual prompt indicating readiness to receive spoken input following activation of the microphone.

15. The electronic toy of claim 10, wherein the remote server is configured to apply content filtering to the text response to ensure the response is appropriate for a target user population.

16. The electronic toy of claim 10, wherein the wireless communication module comprises a Wi-Fi module configured to connect the toy to a wireless local area network.

17. The electronic toy of claim 10, further comprising a storage device, wherein the processor is configured to, upon initial power-up or reset, direct the wireless communication module to operate as a temporary wireless access point and host a captive portal through which a user may provide network credentials, and wherein the processor stores the received credentials in the storage device for use in subsequent connections.

18. The electronic toy of claim 10, wherein the processor operates in a low-power sleep state during the non-listening state, and wherein the motion sensor remains powered during the low-power sleep state to enable detection of the shaking motion.

19. A method of operating an electronic toy, the method comprising: maintaining a processor of the device in a non-listening state in which audio is not actively captured; detecting, by a motion sensor of the device, a shaking motion applied to the device by a user; generating an activation signal in response to the detected shaking motion; transitioning the processor to an active state in response to the activation signal; activating a microphone of the device to capture user speech; transmitting the captured user speech via a wireless communication module to a remote server for processing by an artificial intelligence system; receiving a text response generated by the artificial intelligence system; presenting the text response on a display of the device; and returning the processor to the non-listening state following presentation of the text response, wherein audio is not captured prior to detection of the shaking motion.

20. The method of claim 19, wherein the device does not include a speaker, and wherein the text response is presented to the user solely through the display.

21. The method of claim 19, further comprising applying, by the remote server, content filtering to the text response to ensure the response is appropriate for a target user population prior to transmitting the text response to the device.

22. The method of claim 19, further comprising, upon transitioning the processor to the active state, verifying network connectivity before activating the microphone, and returning the processor to the non-listening state without capturing audio when network connectivity is unavailable.

23. The method of claim 19, wherein the activation signal is generated only when the shaking motion meets or exceeds a predetermined threshold.
